(19) United States
(12) Patent Application Publication
(10) Pub. No.: US 2005/0080786 A1
(43) Pub. Date: Apr. 14, 2005

(54) System and method for customizing search results based on searcher's actual geographic location

(76) Inventors: Edmund J. Fish, Dulles, VA (US); Bradley Chase Harrison, New York, NY (US)

Correspondence Address: GLENN PATENT GROUP, 3475 EDISON WAY, SUITE L, MENLO PARK, CA, 94025, US

(21) Appl. No.: 10/685,748

(22) Filed: Oct. 14, 2003

(51) Int. Cl. G06F 17/30

(52) U.S. Cl. 707/10

(57) ABSTRACT

This invention provides a system and method for customizing search results based on the searcher's actual geographic location when the search query was sent out via a wireless device. The searcher's geographic location information is extracted from, for example, the signals carrying the search query. The search engine compares the searcher's actual geographic location information against the geographic location information contained in the searchable resources to determine one or more parameters and then filters and ranks the search objects based on the determined parameters.

### BACKGROUND OF THE INVENTION

1. Field of the Invention

This invention generally relates to the Internet based search technology. More particularly, the invention relates to a system and method for customizing search results based on the searcher's actual geographic location when the search query was sent from a wireless device.

2. Description of the Related Art

When a user searches an object from the searchable Web resources, it is often important to obtain results that are geographically relevant. More particularly, many searchers seek to identify geographically proximate results. For example, when one searches for a medical doctor, it is important to find the medical doctors who are in the same city or the cities nearby.

Various schemes have been devised to enable specification of geographic regions of interest and to limit search results to those geographic regions of interest. However, depending upon the size of the geographic region of interest, such results may or may not be highly relevant. In addition, results within a geographic region of interest are not sorted based on relative distance to the user, leaving the user without information that may be important or at least useful, in evaluating the search results.

Conventional search engines use the processes to compare input search terms against meta-data in order to identify displayable results. These processes also allow for refined searching of input terms against particular identified types of meta-data. Some of the conventional search engines permit comparison of input search terms against full or partial text.

A typical conventional search engine is Google, which uses PageRank™ to rank Web pages. PageRank™ relies on the uniquely democratic nature of the Web by using its vast link structure as an indicator of an individual page's value. In essence, Google interprets a link from page A to page B as a vote, by page A, for page B. In addition to looking at the sheer volume of votes or links a page receives, Google also analyzes the page that casts the vote. Votes cast by pages that are themselves “important” weigh more heavily and help to make other pages “important.” Important, high-quality sites receive a higher PageRank, which Google remembers each time it conducts a search. Of course, important pages mean nothing to a user if they do not match the user's query. So, Google combines PageRank with sophisticated text-matching techniques to find pages that are both important and relevant to the user's search. Google actually goes beyond the number of times a term appears on a page and examines all aspects of the page's content (and the content of the pages linking to it) to determine if it is a good match for the user's query.

U.S. Pat. No. 5,930,474 discloses a software interface used to organize information predicated upon the geographic area of the resources about which the information is desired. The user is presented with a “viewpoint” map which may include an actual visually displayed map of a selected geographic area, or text information which pertains to the resources associated with the selected geographic area. A geography database, a local content database and a yellow pages database are provided to allow the user to obtain information at different levels. The geography database allows the user to browse through different geographic areas of which are ordered hierarchically, while the local content database includes information about general goods and services available within a given geographic location and the yellow pages database includes information about specific goods and services in the geographic location. Thus, the user is provided with a means whereby information which is associated with particular geographic locations can be readily accessed. U.S. Pat. No. 6,442,544 describes a system and method for organizing search categories for use in an on-line search query engine based on a geographic description. The city list is compiled into entries in a database organized by an official name for each city in the city list. A virtual city list is compiled into entries in a database organized by an unofficial name for each virtual city in a virtual city list. A friendly name list is compiled into entries in a database organized by a pseudonym for each friendly name in a friendly name list. A search query engine includes a user interface receiving a location descriptor presenting the search categories organized by an actual location. The search query engine also includes a resolution module resolving the actual location from the location descriptor using at least one of the official name in the city list, the unofficial name in the virtual city list, and the friendly name in the friendly name list.

U.S. Pat. No. 6,523,021 provides a system and method for efficiently searching directory listing information to obtain more relevant results. The search engine cooperates with a data store having directory listing information to provide listings data to an operator. In an illustrative implementation, the search engine is deployed on a Web site that offers business listing information. The search system includes a user interface to enter search query information, a data storage that houses a variety of directory listing information according to a predefined data taxonomy, and a means for displaying the search results. In operation, the search engine offers a variety of search options, e.g. search by business name, by business categories levels, by geographic position of the user or the business, or a combination thereof. Depending on the search query entered, the search engine performs either a bounded search (i.e. a search bounded to a specific geographic area), a proximity search (i.e. a search proximate to a computed centroid), or a combination of the two to find the most relevant directory listings. Using the inputted search qualifiers, the search engine polls the data store according to a predefined set of rules and instructions for the relevant directory listing information. The rules are directly related to the taxonomy of the data store.

European Patent No. EP1139681 provides a method for adapting a user interface to the user's current situation. The method involves a user specifying a home-area interface, for example, a web browser home page, and an “away” interface. When the user connects to a network using a device and calls up his browser home page, a determination is made of the location of the device in order to decide which version of the home page is to be served back to the user device by the home-page server of the user. The “away” home page includes specific types of local data of interest to the user such as best local restaurants. When asked to provide the “away” home page, the home-page server uses this information to find the URLs of local special interest Web sites carrying the relevant type of data, the server inserting these URLs in the “away” home page before providing it to the user device concerned.

European Patent No. EP1176840 discloses an information service system which provides search and notifications to inform when certain people such as friends, family and business contacts are nearby so as to facilitate communications with those people. Users may define lists of people whose locations may be tracked by positioning equipment based on personal communications/computing devices carried by the people. The information service processes the location information to identify those of the listed people that are in the user's vicinity and provides notifications and user-initiated search results informing the user such as via the user's personal communications/computing device.

AOL's YellowPages is a client application which enables a user to search businesses within 25 miles of a city. The user may choose a location by entering city and state or the zip code. The query may be either a business name or a business category. The client application uses a stored cookie to determine zip code and returns the user a list of businesses which can be sorted by distance, alphabets, or rating.

None of these solutions provides search results based on the user's actual geographic location information. Further, none of them is applicable to the circumstances where the user sends the search query from a wireless device and searches for something nearby.

What is desired is a system and method for customizing search results based on the searcher's actual geographic location when the search request was sent from a wireless device.

### SUMMARY OF THE INVENTION

This invention provides a system and method for customizing search results based on the searcher's actual geographic location when the search query was sent out via a wireless device. The server extracts the searcher's geographic location information (GLI) the signals carrying the search query and calculates one or more reference parameters such as a reference distance based on the GLI. The search engine in the server compares uses the reference parameters as filtering parameters against the geographic information contained in the searchable resources (or search objects) to determine the distance between the searcher's actual geographic location and the geographic location of each search object and then ranks the search results (i.e. the content-relevant search objects) by distance or by other parameters such as by alphabet or by rating.

In one preferred embodiment as illustrated in FIG. 2 and FIG. 3, the filter and sorter are incorporated in the server side. The user sends a search query from a wireless device such as a cellular phone or an interactive pager. The radio signals carrying the search query are transmitted to the server via a wireless communication system. The server extracts the user's actual geographic location information (GLI), such as the automatic location identification (ALI) according to the definition of Federal Communications Commission's E911 rules, and calculates one or more reference parameters based on the GLI data. Then the server sets filtering parameters based on the reference for the filter of the search engine. The sorter sorts the search engine's outputs based on the settings configured by the server. In this embodiment, the user can only receive pre-sorted search results.

In another preferred embodiment as illustrated in FIG. 4 and FIG. 5, the wireless device is empowered with a sorter which enables the user to check through the returned search results. For example, the user may choose to view the returned search results by distance, by alphabet, or by rating. The sorter is incorporated into the wireless device's user interface supported by an embedded program.

In another preferred embodiment as illustrated in FIG. 6 and FIG. 7, the wireless device is empowered with a micro browser which enables the user to perform some browsing tasks and therefore the user can set more sophisticated search query.

Yet in another preferred embodiment as illustrated in FIG. 8 and FIG. 9, the wireless device is empowered with a full browser which provides the user more capabilities in configuring the search query and utilizing the returned search results.

### BRIEF DESCRIPTION OF THE DRAWINGS

FIG. 1A is schematic diagram illustrating a wireless search system which includes a wireless device, a wireless communication system, and a server communicatively coupled to the Internet, according to this invention;

FIG. 1B is a diagram illustrating an exemplary filtering scheme;

FIG. 2 is a schematic block diagram illustrating one preferred embodiment according to the invention;

FIG. 3 is a flow diagram illustrating a customized search process according to the embodiment of FIG. 2;

FIG. 4 is a schematic block diagram illustrating another preferred embodiment according to the invention;

FIG. 5 is a flow diagram illustrating a customized search process according to the embodiment of FIG. 4;

FIG. 6 is a schematic block diagram illustrating another preferred embodiment according to the invention;

FIG. 7 is a flow diagram illustrating a customized search process according to the embodiment of FIG. 6;

FIG. 8 is a schematic block diagram illustrating another preferred embodiment according to the invention; and

FIG. 9 is a flow diagram illustrating a customized search process according to the embodiment of FIG. 8.

### DETAILED DESCRIPTION OF THE INVENTION

In various contexts, a geographic location may be identified for a high proportion of searchable Web resources. For example, Web pages typically include geographic location information (GLI) such as an address and/or telephone number. Hence GLI can be a searchable criterion.

This invention contemplates comparing the GLI associated with the searcher against the GLI associated with searchable resources to calculate the distance there between, and filtering and ranking the search results based on the calculated distances.

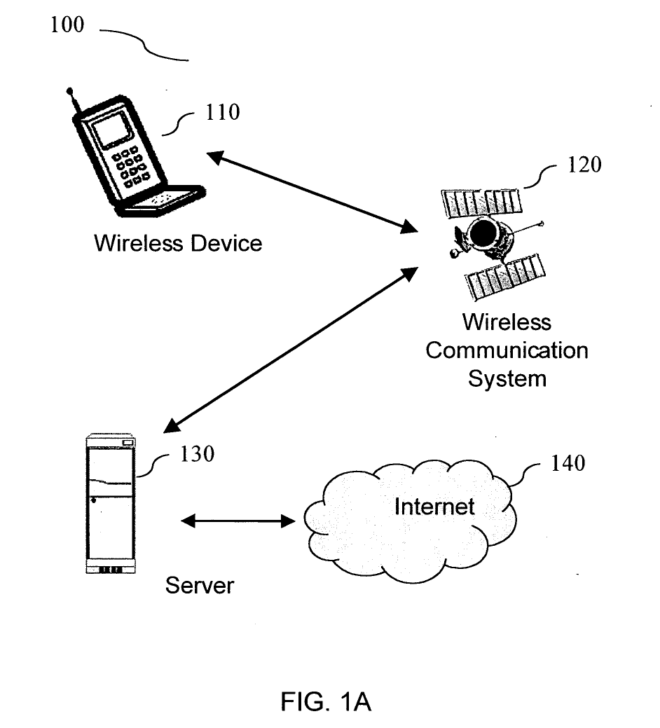

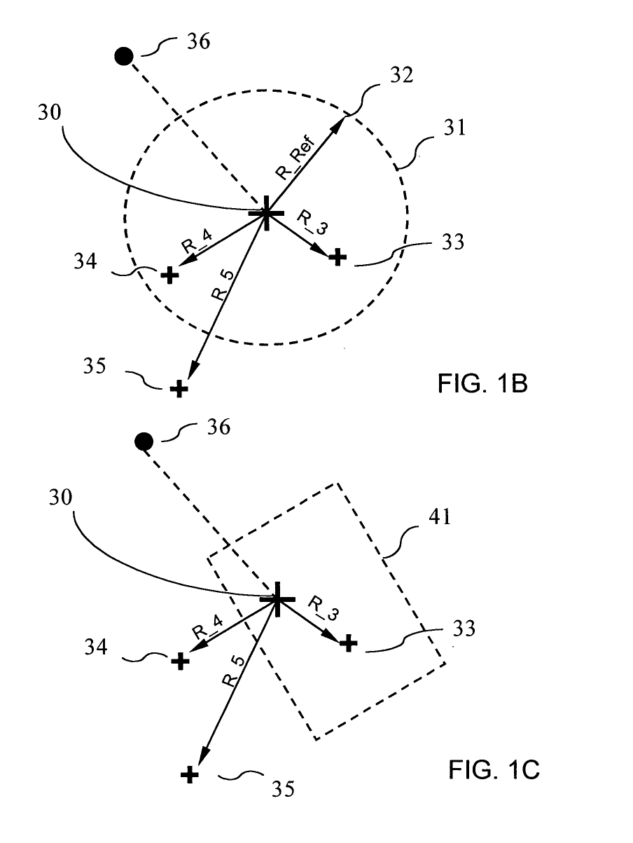

FIG. 1A is schematic diagram illustrating a wireless search system 100 which includes a wireless device 110, a wireless communication system 120, and a server 130 communicatively coupled to the Internet 140. The user uses the wireless device to send the server 130 a search query from anywhere as long as a connection can be established via the wireless communication system 120. The server 130 extracts the user's actual geographic location information (GLI), such as the automatic location identification (ALI) according to the definition of Federal Communications Commission's E911 rules, by processing the data received from the wireless communication system 120. The extracted GLI is used to determine one or more reference parameters for filtering and sorting the search results. The user can obtain the most relevant information by scrolling a list of search results. The filtering and sorting function may be placed in the client device side or the server side depending on different deployments.

FIG. 1B is a diagram illustrating an exemplary filtering scheme wherein the processor in the server determines the searcher's GLI 30 which includes the coordinates of the user's geographic location relative to a receiving station (or tower) 36 of the wireless communication system and calculates a set of reference parameters used to determine a search region 31 based on the GLI 30 and a predefined scope parameter such as the reference radius R-Ref 32. The processor then sets one or more filtering parameters for the search engine in the server. The search engine compares the filtering parameters against the geographic information contained in the searchable resources. In this example, the resources 33-34 are included because they fall in the searching region 31 and the resource 35 is excluded because it falls outside of the searching region 31. If both the resource 33 and the resource 34 satisfy all filtering parameters, they will be returned to the user. The returned search results can be ranked by distance or by other standards. When a “sorting by distance” standard is configured, the resource 34 should be ranked before the resource 33 because the former is closer to the searcher's location 30 than the latter. In most cases, “sorting by distance” is a default sorting method. For example, the search results shown in the wireless device is pre-sorted by distance. But the user can re-sort the returned results by alphabet or by rating.

FIG. 1C is a diagram illustrating another exemplary filtering scheme wherein the processor in the server determines the searcher's GLI 30 which includes the coordinates of the user's geographic location relative to a receiving station (tower) 36 of the wireless communication system and calculates a set of reference parameters used to determine the filtering parameters for a search region 41 based on the GLI 30 and a predefined scope parameter or parameters such as one or more zip codes (or telephone area codes). Then the search engine in the server compares the filtering parameters against the geographic information contained in the searchable resources. In this example, the resource 33 is included because it falls in the searching region 41 and the resources 34-35 are excluded because they fall outside of the searching region 41.

In one embodiment, for example, the wireless device 110 is a cellular phone with which a user can establish wireless connection with another user via the wireless communication system 120 which includes a plurality of transmitters, i.e. wireless towers. A transmitter's span of coverage is called a cell, which is typically sized at about ten square miles. As the user moves from one cell or area of coverage from one to another, the phone signals are effectively passed on to the local cell transmitter. The wireless device 110 also has a data networking feature which enables the communication with the server 130. The wireless communication system 120 keeps track of the user's cellular phone's geographic location information in a database. The server 130 can processes the newest location information and use it to set one or more filtering parameters for its search engine.

In various deployments such as these described herein, the wireless device 110 and the wireless communication system 120 are compatible with, or supported by one or more of: Advanced Mobile Phone System (AMPS), Digital Advanced Mobile Phone Service (DAMPS), Global System for Mobile communications (GSM), General Packet Radio Service (GPRS), Personal Communications Services (PCS), Bluetooth, and Global Positioning System (GPS).

Advanced Mobile Phone System (AMPS) is primarily for analog signal cellular phone service using a range of frequencies between 824 MHz and 894 MHz. Each service provider can use half of the 824-894 MHz range for receiving signals from cellular phones and half the 869-894 MHz range for transmitting to cellular phones. The bands are divided into 30 kHz sub-bands, called channels. The receiving channels are called reverse channels and the sending channels care called forward channels. The division of the spectrum into sub-band channels is achieved by using frequency division multiple accesses (FDMA). The signals received from a transmitter cover an area called a cell. As a user moves out of the cell's area into an adjacent cell, the user's phone begins to pick up the new cell's signals without any noticeable transition. The signals in the adjacent cell are sent and received on different channels than the previous cell's signals so that the signals do not interfere with each other.

Digital Advanced Mobile Phone Service (DAMPS) is a digital version of AMPS. DAMPS adds time division multiple access (TDMA) to AMPS to get three channels for each AMPS channel, tripling the number of calls that can be handled on a channel.

Global System for Mobile communications (GSM) is a digital wireless telephone system operating in the 900-MHz and 1800-MHz frequency ranges. GSM digitizes and compresses data, then sends it down a channel with two other streams of user data, each in its own time slot. GSM networks deliver high quality and secure wireless voice and data services with full roaming capabilities across countries. In those countries that use GSM 900 MHz and 1800 MHz, a cellular phone user can buy one phone and uses it in different countries where the GSM standard is supported. To connect to the specific service providers in these different countries, the GSM-user simply switches the subscriber identification module (SIM) card, which is a small removable disk that slips in and out of GSM cell phones. The SIM card stores all the connection data and identification numbers the user needs to access a particular wireless service provider. In addition to international compatibility, the GSM standard supports a number of useful features, such as encryption technology, data networking, Group III facsimile services, short message service (SMS) for text messages and paging, call forwarding, caller ID, and multi-party conferencing.

General Packet Radio Service (GPRS) is a system allowing information to be sent and received across a wireless telephone network. Theoretical maximum speeds of up to 171.2 kilobits per second (kbps) are achievable with GPRS using all eight timeslots at the same time. This is about ten times as fast as current circuit switched data services on GSM networks. GPRS facilitates instant connections whereby information can be sent or received immediately as the need arises, subject to radio coverage. No dial-up modem is necessary. GPRS also facilitates several new applications that have not previously been available over GSM networks due to the limitation in speed of circuit switched data (9.6 kbps) and message length of the short message service (160 characters). It fully enables Internet applications the user is using on desktop from web browsing to chat over the wireless network. Other new applications for GPRS include file transfer and home automation—the ability to remotely access and control in-house appliances and machines.

GPRS involves overlaying a packet based air interface on the existing circuit switched GSM network. This gives the user an option to use a packet-based data service. With GPRS, the information is split into separate but related “packets” before being transmitted and reassembled at the receiving end. Packet switching means that GPRS radio resources are used only when users are actually sending or receiving data. Rather than dedicating a radio channel to a wireless data user for a fixed period of time, the available radio resource can be concurrently shared between several users. This efficient use of scarce radio resources indicates that large numbers of GPRS users can potentially share the same bandwidth and be served from a single cell. The actual number of users supported depends on the application being used and how much data is being transferred. Because of the spectrum efficiency of GPRS, there is less need to build in idle capacity that is only used in peak hours. GPRS therefore lets network operators maximize the use of their network resources in a dynamic and flexible way, along with user access to resources and revenues.

GPRS fully enables Mobile Internet functionality by allowing internetworking between the existing Internet and the new GPRS network. Any service that is used over the fixed Internet, e.g. File Transfer Protocol (FTP), web browsing, chat, email or telnet, becomes available over the wireless network due to GPRS. Because it uses the same protocols, the GPRS network can be viewed as a sub-network of the Internet with GPRS capable wireless phones being viewed as wireless hosts. This means that each GPRS terminal can potentially have its own IP address and can be addressable as such.

Personal Communications Services (PCS) is a wireless phone service similar to cellular phone service with an emphasis on personal service and extended mobility. While cellular was originally created for use in cars, PCS was designed from the ground up for greater user mobility. PCS has smaller cells and thus requires a larger number of antennas to cover a geographic area. PCS phones use frequencies between 1850 MHz and 1990 MHz. While it is based on TDMA, PCS has 200 kHz channel spacing and eight time slots instead of the typical 30 kHz channel spacing and three time slots found in digital cellular.

In various deployments such as these described herein, Bluetooth wireless technology may be incorporated. Bluetooth is a specification for short-range radio links between wireless computers, wireless phones, digital cameras, and other portable devices. The Bluetooth specification contains the information necessary to ensure that diverse devices supporting the Bluetooth wireless technology can communicate with each other worldwide. Unlike many other wireless standards, the Bluetooth wireless specification includes both link layer and application layer definitions for product developers and supports data, voice, and content-centric applications. Radios that comply with the Bluetooth wireless specification operate in the unlicensed, 2.4 GHz radio spectrum ensuring communication compatibility worldwide. These radios use a spread spectrum, frequency hopping, full-duplex signal at up to 1600 hops/sec. The signal hops among 79 frequencies at 1 MHz intervals to give a high degree of interference immunity. Up to seven simultaneous connections can be established and maintained.

In various deployments such as these described herein, the wireless communication system 120 is coupled to Global Positioning System (GPS), which is a worldwide radio-navigation system formed from a constellation of twenty-four satellites and their ground stations. GPS uses the satellites as reference points to calculate positions on the earth accurate to a matter of meters. Depending on the user's geographic location, the GPS receiver samples data from up to six satellites, it then calculates the time taken for each satellite signal to reach the GPS receiver, and from the difference in time of reception, determines the user's location. GPS receivers now can be miniaturized to just a few small integrated circuits and thus can be practically incorporated into lightweight wireless devices such as cellular phones, pagers, PDAs, wireless laptops, etc.

To improve public safety by encouraging and facilitating the prompt deployment of a nationwide, seamless communications infrastructure for emergency services, the Wireless Communications and Public Safety Act of 1999 (911 Act), effective on Oct. 26, 1999, directs the Federal Communications Commission (FCC) to make 911 the universal emergency number for all telephone services. Accordingly, FCC revised the 911 requirements (E911). The revised requirements are divided in two phases. Phase I requires wireless carriers to deliver to the emergency dispatcher the telephone number of a wireless handset originating a 911 call, as well as the location of the cell site or base station receiving the 911 call, which provides a rough indication of the caller's location. Phase II requires carriers to deliver more specific latitude and longitude location information, known as Automatic Location Identification (ALI), to the dispatcher. With compliance of FCC's requirements, GPS or other location tracking system will be widely used in cellular phones. Regardless what kind if location tracking system is incorporated in the wireless communication channel, the ALI data can be used for the customized search according to this invention.

The search engine in the server may be either an indexing search engine which uses an automated program, called search engine spider, to index Web sites into a large database, or a search directory which is human reviewed category listings that rely on submissions from the site owners. A search engine spider is a piece of software that acts like an electronic librarian who cuts out the contents pages of each book in every library in the world, sorts them into an extremely large master index and then builds an electronic bibliography that stores this information as a database index. Some software spiders can index over a million documents a day. The basic principle is that the index is built from the actual content of each site. In the present information, the index is closely related to the spatial relationship between the searcher's actual geographic location and the geographic location indicated in the site content. The spatial relationship, as mentioned above, can be determined by relative distance, the same or neighboring zip codes, the same or neighboring telephone area codes, etc. In other words, the search engine in this invention only crawls these Web sites which are both content relevant and location relevant.

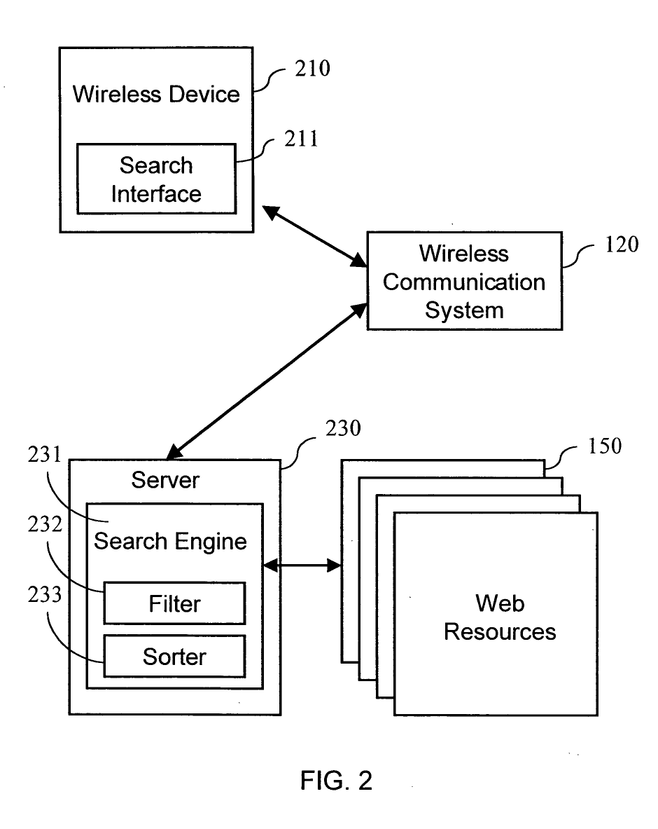

FIG. 2 is a schematic block diagram illustrating one preferred embodiment according to the invention. The wireless device 210 is a lightweight wireless device which includes a small embedded application providing a user interface 211 from which the user enters a search query. When the user presses a send button, for example, the wireless device 210 sends the radio signals carrying the search query to the transmission system 120 which in turn sends the signals to the server 230. The server 230 processes the signals and extracts the user's actual geographic information, such as the Automatic Location Identification (ALI) data as defined by FCC's E911 rules. The search engine 231 is empowered with a filter 232 and a sorter 233. The filter 232 sets one or more filter parameters based on the GLI data. The search engine 231 tries to do a case-insensitive match of the user's query against a number of predefined parameters such as business name, category, telephone number, zip code, etc. The sorter 233 sorts the search results, for example, by distance between the searcher's actual geographical location and the location of each search object returned. Then, the server 230 returns the sorted search results to the wireless device 210. The user can obtain the most relevant information by scrolling up and down through a list of search results.

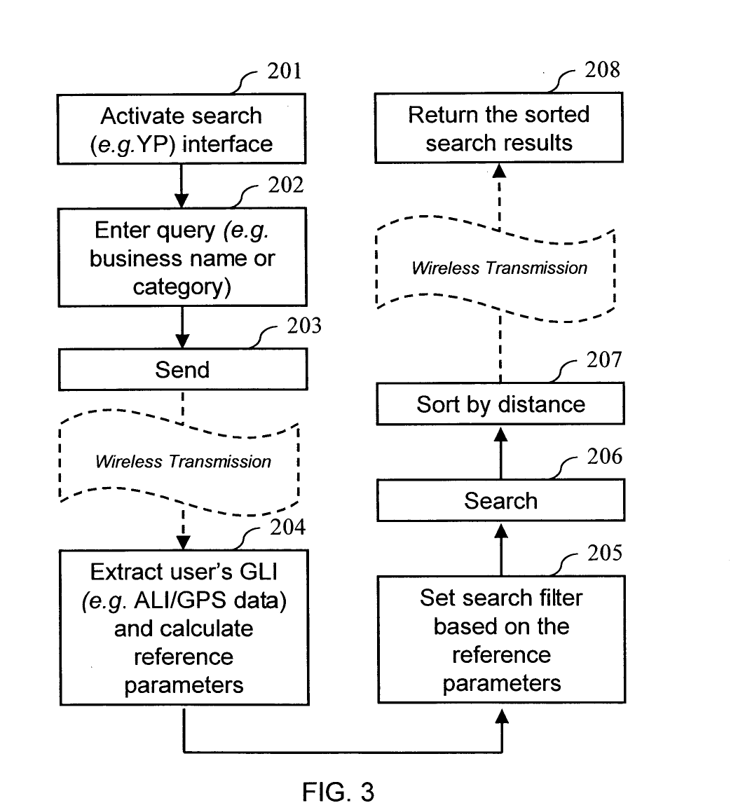

The process for customized search according to the embodiment of FIG. 2 is illustrated in FIG. 3. The process includes the following steps:
Step 201: the user activating the search interface in the wireless device;
Step 202: entering the query, such as a business name or category;
Step 203: pressing a send button or clicking a virtual send button;
Step 204: the server extracting the user's GLI and calculating a reference region parameters associated with the GLI;
Step 205: setting filter parameters based on the calculated reference region parameters;
Step 206: searching (indexing);
Step 207: sorting the search results by distance between the searcher's actual geographical location and the geographic location of the search object; and
Step 208: returning the sorted search results to the wireless device.

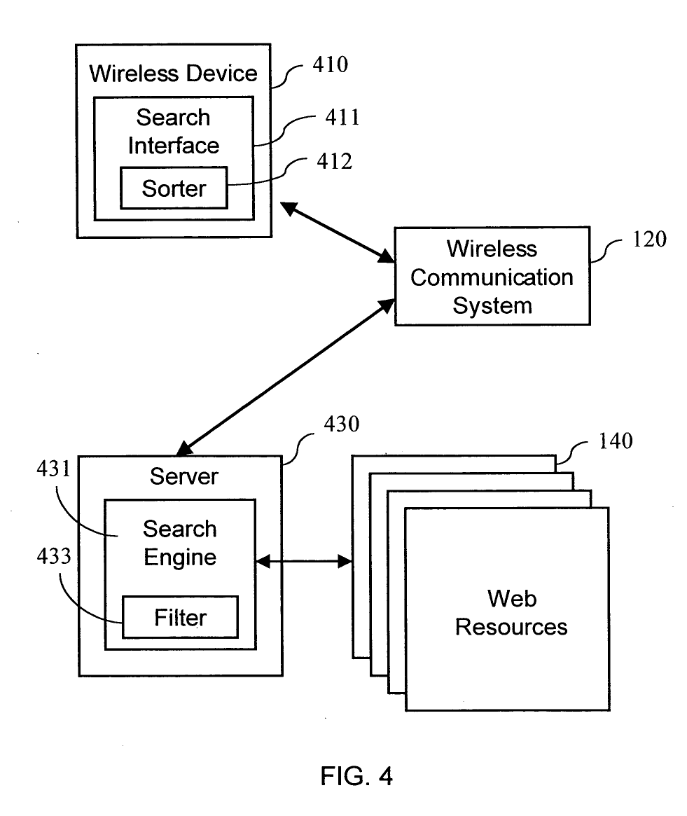

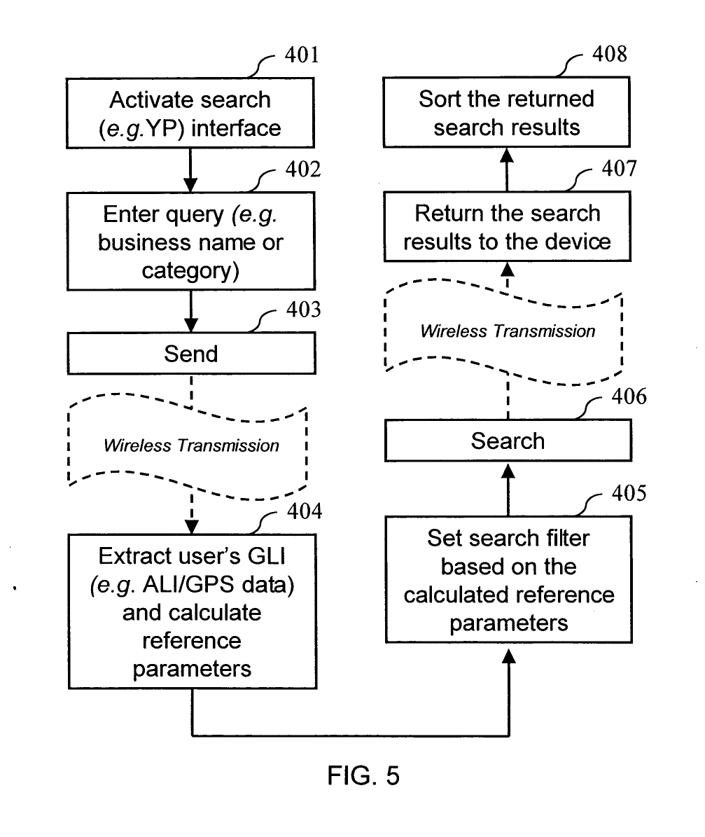

FIG. 4 is a schematic block diagram illustrating another preferred embodiment according to the invention. In this embodiment, the wireless device 410 is empowered with a sorter 412 which is incorporated into the search interface 411 supported by a small program embedded in the wireless device. The default sorting criterion is, for example, by distance, and the user can make further sorting of the returned results by giving one or more simple commands. For example, the user may choose to sort the returned results by alphabet or by rating.
The process for customized search according to the embodiment of FIG. 4 is illustrated in FIG. 5. The process includes the following steps:
Step 401: the user activating the search interface in the wireless device;
Step 402: entering the query, such as a business name or category;
Step 403: pressing a send button or clicking a virtual send button;
Step 404: the server extracting the user's GLI such as the ALI/GPS data and calculating a set of reference parameters associated with the GLI;
Step 405: setting filter parameters based on the calculated reference parameters;
Step 406: searching (indexing);
Step 407: returning the search results, which are ranked by distance, to the wireless device; and
Step 408: the user choosing to sort the returned search results by alphabet or by rating.

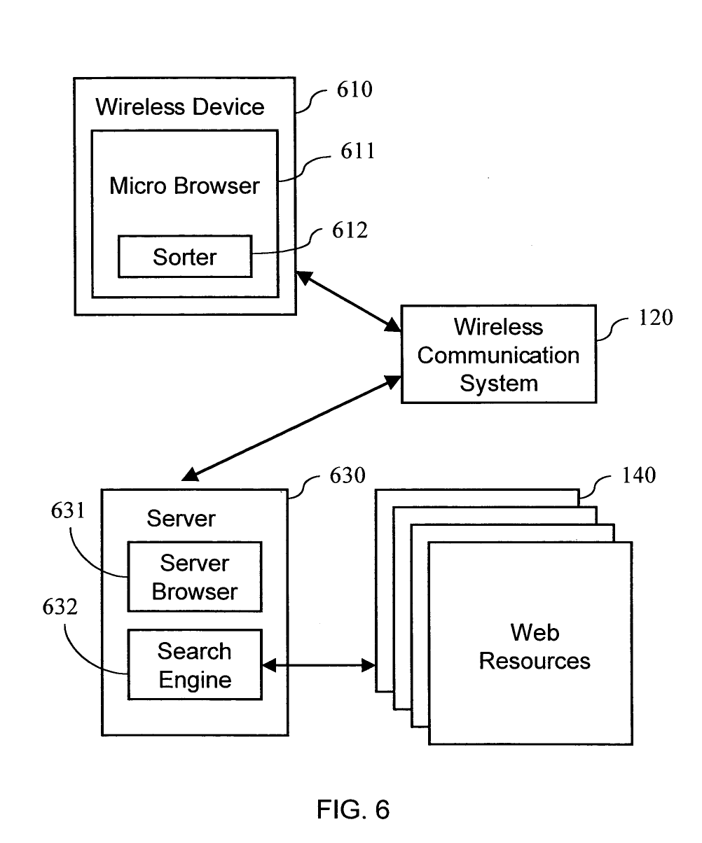

FIG. 6 is a schematic block diagram illustrating another preferred embodiment according to the invention. In this embodiment, the wireless device 610 is empowered with a micro browser 611, which is a part of a cross platform browser for lightweight client devices. The cross platform browser, for example, includes a server browser 631, which is a heavyweight browser engine in the server side, and a client browser engine (e.g. the micro browser 611), which is a lightweight browser engine in a client device, both of which, for example, work under a C++ application framework. The server browser 631 performs browsing functions that require large processing power and RAM, such as HTTP communications, HTML parsing, HTML validation, and layout components, based on constraints defined by the client device. The micro browser 611 only performs a minimal task of implementing a customizable user interface to display a highly optimized, pre-rendered representation of the Web pages. Here in the embodiment illustrated in FIG. 6, the user has more capabilities in configuring search limitations using the micro browser 611. Further, using the more powerful sorter 612, the user has more options in utilizing the search results returned from the search engine 632.

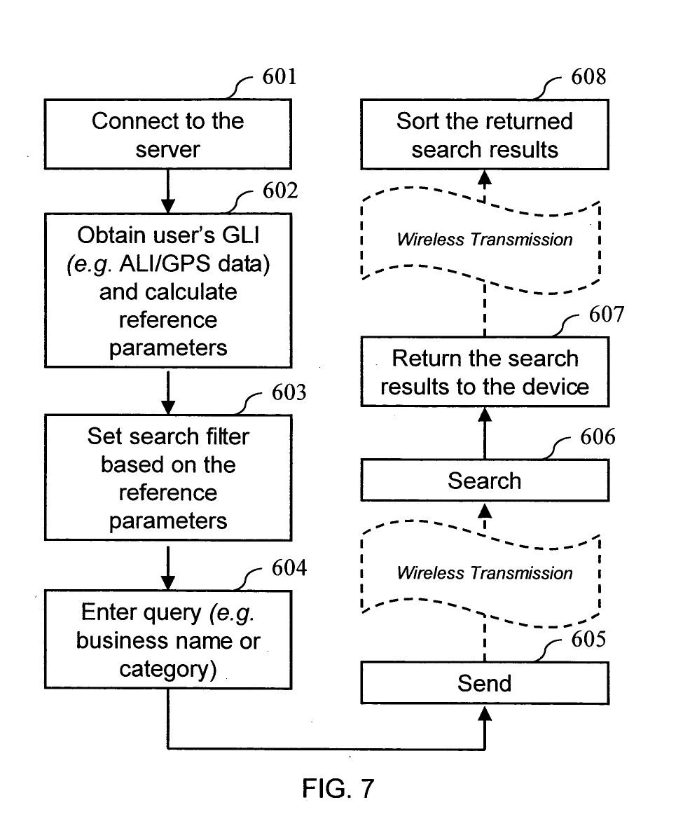

The process for customized search according to the embodiment of FIG. 6 is illustrated in FIG. 7. The process includes the following steps:
Step 601: the user connecting the wireless device to the server;
Step 602: obtaining the user's GLI such as the ALI/GPS data and calculating a set of reference parameters associated with the GLI;
Step 603: setting filter parameters based on the calculated reference parameters;
Step 604: entering the query, such as a business name or category;
Step 605: sending the query to the server;
Step 606: the search engine at the server side making a search (indexing);
Step 607: returning the search results, which are ranked by distance, to the wireless device; and
Step 608: the user choosing to sort the returned search results by alphabet or by rating.

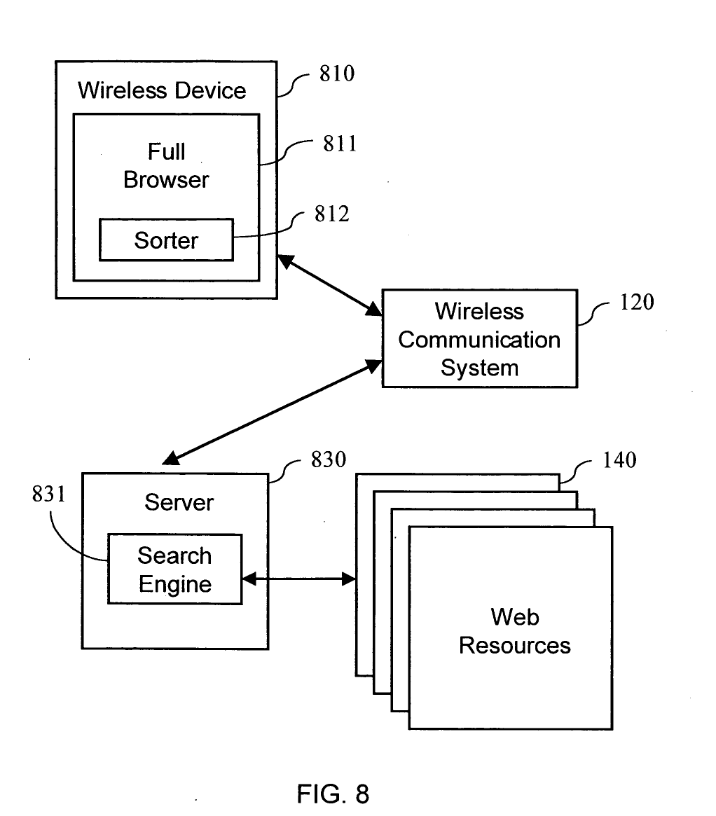

FIG. 8 is a schematic block diagram illustrating another preferred embodiment of the invention. In this embodiment, the wireless device 810 is empowered with a full browser 811 which allows the user to read hypertext and provides various means of viewing the contents of nodes pages and of navigating from one page to another.

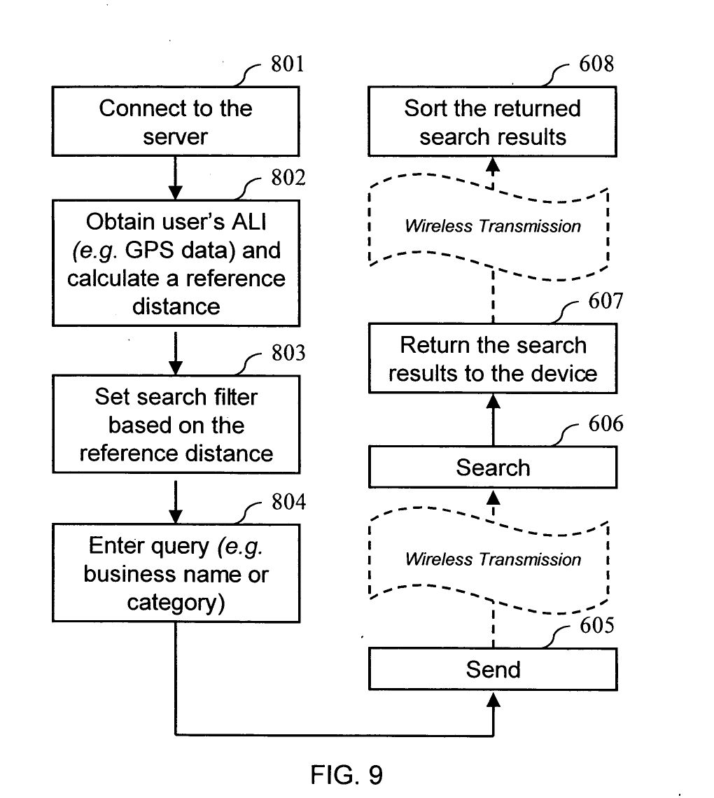

The process for customized search according to the embodiment of FIG. 8 is illustrated in FIG. 9. The process includes the following steps:
Step 801: the user connecting the wireless device to the server;
Step 802: obtaining the user's GLI such as the ALI/GPS data and calculating a set of reference parameters associated with the ALI;
Step 803: setting filter parameters based on the calculated reference parameters;
Step 804: entering the query, such as a business name or category;
Step 805: sending the query to the server;
Step 806: the search engine at the server side making a search (indexing);
Step 807: returning the search results, which are ranked by distance, to the wireless device; and
Step 808: the user choosing to sort the returned search results by alphabets or by rating.

Although the invention is preferably described herein with reference to the preferred embodiment, one skilled in the art will readily appreciate that other applications may be substituted for those set forth herein without departing from the spirit and cope of the present invention.

Accordingly, the invention should only be limited by the claims included below.

1. A system for responding to a search query from a user who uses a wireless device, said wireless device being communicatively coupled via a wireless communication system to a server on the Internet, said server comprising:
a processor on which a search engine application runs,
said processor being configured to:
extract the user's geographic location information from the signals carrying the search query;
calculate a set of reference parameters based on the user's geographic location information;
set one or more filtering parameters for said search engine application, said filtering parameters being associated with said reference parameters, said search engine application comparing said filtering parameters against the corresponding parameters contained in the geographic location information identifying each search object and ranking relevant search objects by the distance between the user's geographic location and the geographic location associated with each relevant search object; and
return search results to the user via said wireless communication system.

2. The system of claim 1, wherein said wireless device comprises a graphical user interface which is used to enter and send said search query and display said returned search results.

3. The system of claim 2, wherein said graphical user interface comprises a sorting means which is used to re-sort said returned search results by a predefined category.

4. The system of claim 3, wherein said predefined category is any of:
by distance;
by alphabet; and
by rating.

5. The system of claim 4, wherein a default category for said sorting means is by distance.

6. The system of claim 2, wherein said graphical user interface is coupled to a micro Web browser.

7. The system of claim 2, wherein said graphical user interface is coupled to a full Web browser.

8. The system of claim 1, wherein said set of reference parameters comprises any of:
one or more telephone area codes;
one or more zip codes;
the coordinates of the user's geographic location relative to a receiving station of said wireless communication system; and
a predetermined distance as a reference radius of a search region.

9. A method for responding to a search query from a user who uses a wireless device, said wireless device being communicatively coupled via a wireless communication system to a server on the Internet, the method comprising the steps of:
extracting the user's geographic location information from the signals carrying the search query;
calculating a set of reference parameters based on the user's geographic location information;
setting filtering parameters, based on said reference parameters, for a search engine application running on said server;
comparing said filtering parameters against the corresponding parameters contained in the geographic location information identifying each search object; and
returning search results to the user via said wireless communication system.

10. The method of claim 9, further comprising the step of:
ranking relevant search objects by the distance between the user's geographic location and the geographic location associated with each relevant search object.

11. The method of claim 9, wherein said wireless device comprises a graphical user interface which is used to enter and send said search query and display said returned search results.

12. The method of claim 11, further comprising the step of:
re-sorting said returned search results using a sorting means based on a predefined category, said sorting means being coupled to said graphical user interface.

13. The method of claim 12, wherein said predefined category is any of:
by distance;
by alphabet; and
by rating.

14. The method of claim 13, wherein a default category for said sorting means is by distance.

15. The method of claim 11, wherein said graphical user interface is coupled to a micro Web browser.

16. The method of claim 11, wherein said graphical user interface is coupled to a full Web browser.

17. The method of claim 9, wherein said set of reference parameters comprises any of:
one or more telephone area codes;
one or more zip codes;
the coordinates of the user's geographic location relative to a receiving station of said wireless communication system; and
a predetermined distance as a reference radius of search region.
